(19) United States
(12) Patent Application Publication
(10) Pub. No.: US 2001/0046426 A1
(43) Pub. Date: Nov. 29, 2001

(54) Resilient clip fastener

(76) Inventors: Daniel J. Lubera, Roseville, MI (US); Jacob A. Siudym II, Emmett, MI (US); Robert Osterland, St. Clair, MI (US)

Correspondence Address: Hamess, Dickey & Pierce, P.L.C., P.O. Box 828, Bloomfield Hills, MI, 48303, US

(21) Appl. No.: 09/771,962

(22) Filed: Jan. 29, 2001

Related U.S. Application Data
(60) Provisional application No. 60/192,375, filed on Mar. 27, 2000.

(51) Int. Cl. F16B 37/04

(52) U.S. Cl. 411/182

(57) ABSTRACT

A resilient clip for engaging a structure having a body portion and a spacing structure. The body portion includes a pair of flanges, a pair of wing members and a pair of abutting flanges and is configured to be partially inserted through a hole in the structure and engage the surfaces of the structure. The spacing structure has first and second flange members, with the first flange member being coupled to the flange portion of the body portion and the second flange member being coupled to an outer edge of the first flange member and tapering downwardly toward the body portion and outwardly from the flange portion.

### CROSS-REFERENCE TO RELATED APPLICATIONS

This application claims the benefit of U.S. Provisional Application Serial No. 06/192,375 filed Mar. 27, 2000 entitled “Fastener Assembly for Automotive Headliner”. Other features of the present invention are discussed and claimed in commonly assigned copending U.S. application Ser. No. ______ entitled Resilient Clip Fastener filed on even date herewith.

### TECHNICAL FIELD

The present invention relates generally to resilient clip fasteners and more particularly to a resilient clip fastener that employs a plurality of wing members to secure the body portion of the resilient clip to a structure. More specifically, the present invention relates to a resilient clip fastener having a construction that utilizes wing member to permits the clip to be inserted with a relatively low insertion force while resisting relatively high withdrawal forces. The invention also relates to a resilient clip fastener having a construction that accounts in several manners for part-to-part variation between the structures that are to be fastened together.

### BACKGROUND OF THE INVENTION

Many current vehicles employ resilient clips to secure various components to the vehicle body. One such application concerns assist handles that mount to the roof of the vehicle above the doors. Such assist handles serve not only to provide occupants with a convenient point to grasp during ingress to and egress from the vehicle, but also enable occupants to stabilize their upper body during operation of the vehicle. In order to serve these functions, it is necessary for such assist handles to withstand loads of upwards of 250 pounds force without pulling away form the anchor points in the sheet metal of the vehicle.

During assembly of the vehicle, it is conventional procedure of the entire headliner assembly to be installed onto the interior roof of the vehicle in a single operation. In other words, the headliner assembly, with the assist handles and other roof mounted components already attached, is passed through either the windshield or backlight opening of the vehicle body on the assembly line and then the headliner assembly is secured by line operators to the interior roof of the vehicle. In order to accomplish this assembly task, the headliner assembly is typically equipped with numerous fasteners, located around the periphery of the headliner assembly as well as at predetermined locations around the interior area of the headliner, that are adapted to penetrate through corresponding holes located in the reinforcing sheet metal members of the roof. It is the responsibility of the line operators to properly orient the headliner assembly beneath the interior roof of the vehicle and press the fasteners into the various mounting holes in the reinforcing sheet metal members to secure the headliner assembly to the roof the vehicle.

For aesthetic reasons, the headliner fasteners are typically secured in some fashion to the backside of the headliner so that they are not visible from the interior of the vehicle after the headliner assembly is installed. Consequently, it is often incumbent upon the line operators to blindly “feel” for the location of the mounting holes with their fingers before pressing the fasteners into the holes from the opposite show-surface side of the headliner.

Due to slight misalignments which can occur between the fasteners and their corresponding mounting holes, some of the fasteners may not be properly seated and secured to the sheet metal. This condition is especially problematic when dealing with the fasteners that serve to anchor the roof mounted assist handles. Because these fasteners must withstand substantially higher removal forces than the fasteners that serve merely to hold the headliner in place, they are typically less forgiving of misalignment problems, which can result in a significant increase in the required insertion force, thus greatly increasing the likelihood of improper installation. Under the circumstances, the removal forces that the fasteners can withstand before separating from the sheet metal are greatly compromised.

Accordingly, there remains a need in the art for an improved fastener having a relatively low installation force and a relatively high removal force that is relatively more tolerant of misalignment problems. Ideally, the fastener should be inexpensive to manufacture, reliable and simple to install. Furthermore, the fastener should be particularly adapted for securing structures to one another in a manner which minimizes vibration and the concomitant noise problems that are often associated with such fasteners.

### SUMMARY OF THE INVENTION

In one preferred form, the present invention provides a resilient clip for engaging a structure. The resilient clip includes a body portion having a pair of flanges, a pair of wing members and a pair of abutting flanges. Each of the wing members has a base portion that is coupled to an associated one of the flanges. A first one of the wing members is twisted about a first axis in a first direction and a second one of the wing members is twisted about a second axis in the first direction. Each of the wing members terminates at a tip portion that is angled downwardly toward the base portion such that a portion of an associated one of the wing members nearest a central axis of the body portion extends above an associated portion of the wing member furthest from the central axis of the body portion. The tip portions are configured to engage a first side of the structure and position a second side of the structure against the abutting flanges.

In another preferred form, the present invention provides a resilient clip for engaging a structure. The resilient clip includes a clip structure for insertion into a hole formed into the structure and a spacing structure. The clip structure includes a body portion for engaging the structure to inhibit undesired removal of the clip structure from the hole. The clip structure also including a flange portion. The spacing structure has first and second flange members, with the first flange member being coupled to the flange portion and the second flange member being coupled to an outer edge of the first flange member and tapering downwardly toward the body portion and outwardly from the flange portion.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a fastener constructed in accordance with the teachings of the present invention;

FIG. 2 is an exploded perspective view of the fastener of FIG. 1;

FIG. 3 is a sectional view of a portion of the fastener of FIG. 1 illustrating the spacing structure in greater detail;

FIG. 4 is a perspective view of a fastener constructed in accordance with the teachings of an alternate embodiment of the present invention;

FIG. 5 is a front view of a portion of the fastener of FIG. 1, illustrating the clip structure in greater detail;

FIG. 6 is a side elevation view of the fastener of FIG. 1;

FIG. 7 is a bottom view of the fastener of FIG. 1;

FIG. 8 is a sectional view taken along the line 8-8 of FIG. 5;

FIG. 9 is a partial sectional view similar to that of FIG. 8 but illustrating an alternate manner of twisting the wing members;

FIG. 10 is an enlarged portion of FIG. 5, illustrating the construction of the tip portion of the wing member in greater detail;

FIG. 11 is a view similar to that of FIG. 10 but illustrating an alternate manner of forming the tip portion;

FIG. 12 is a side elevation view of a fastener similar to that of FIG. 1 but having a flange portion and a base that are disposed in a common plane to reduce the installation height of the fastener;

FIG. 13 is an exploded perspective view of a vehicle illustrating an application for the fastener of FIG. 1 wherein the fastener is employed to secure a headliner and assist handle to the roof of a vehicle;

FIG. 14 is a partial sectional view taken along the line 14-14 of FIG. 13 showing the fastener in a fully installed condition; and

FIG. 15 is an exploded perspective view of a vehicle illustrating an application for a fastener similar to that of FIG. 1 wherein several of the fasteners are employed to secure an airbag module and a trim cover to a vehicle body structure.

### DETAILED DESCRIPTION OF THE PREFERRED EMBODIMENT

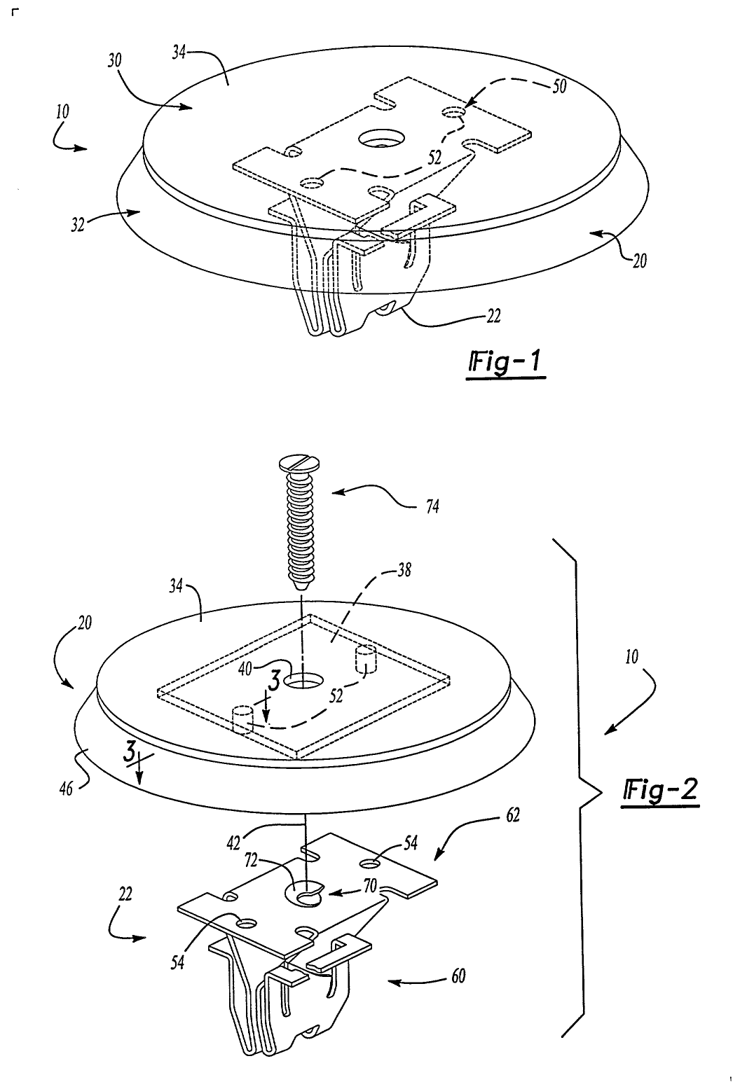

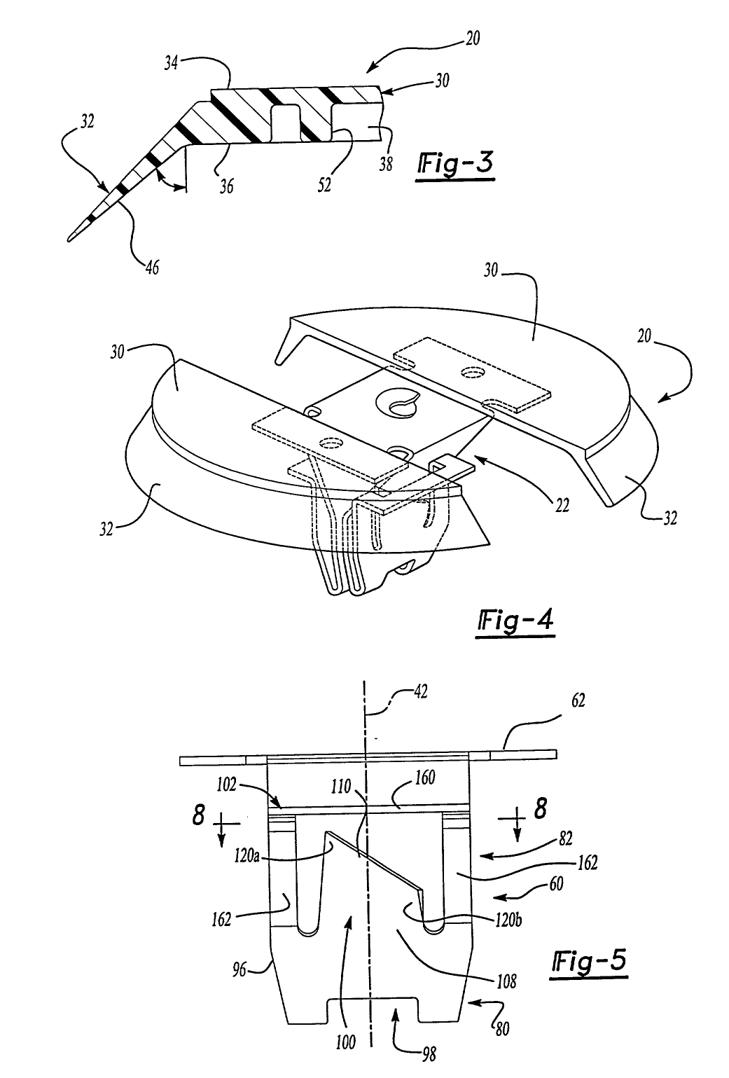

With reference to FIGS. 1 and 2 of the drawings, a resilient clip fastener constructed in accordance with the teachings of a first embodiment of the present invention is generally indicated by reference numeral 10. Fastener 10 is illustrated to include a spacing structure 20 and a clip structure 22. Spacing structure 20 is preferably unitarily formed from a resilient material, such as plastic, with materials such as polypropylene being particularly well suited for automotive applications. Spacing structure 20 is shown to include a first flange member 30 and a second flange member 32. With additional reference to FIG. 3, the outer surface 34 of the first flange member 30 is substantially flat while the inner surface 36 of the first flange member 30 includes a recess 38. A mounting hole 40 is formed through the center of the first flange member 30 along a central axis 42 of the fastener 10.

In the particular embodiment illustrated, the first flange member 30 is circular in shape and the second flange member 32 is frusto-conical in shape, extending entirely around the perimeter of the first flange member 30 in a continuous and unbroken manner. The second flange member 32 is formed from a wall member 46 that is coupled to an edge of the first flange member 30 and which tapers both outwardly from the first flange member 30 and downwardly toward the clip structure 22. In the example provided, the wall member 46 extends from first flange member 30 at an angle of approximately 45 degrees. The wall member 46 is substantially thinner than first flange member 30, which permits the wall member 46 to deflect outwardly in a resilient manner when a force is applied to the first flange member 30 in a direction normal to the outer surface 34. Configuration in this manner advantageously permits spacing structure 20 to function as a spring for purposes which will be discussed in detail, below. In the particular example provided, the thickness of the first flange member 30 is about 0.090 inches, which the thickness of the tip of wall member 46 is about 0.020 inches.

Those skilled in the art will understand, however, that the spacing structure 20 may be constructed somewhat differently. For example, the first flange member 30 may be formed in another shape, such as an oval; the second flange member 32 may be formed to extend only partially around the perimeter of the first flange member; and/or the second flange member 32 may include a plurality of scallops or stiffening ribs (not shown) which operate to reduce of increase, respectively, the stiffness of the second flange member 32 in a desired manner. Those skilled in the art will also understand that the spacing structure 20 may also be configured to include a plurality of first and second flange members 30 and 32, as shown in FIG. 4, with each of the first flange members 30 and an associated one of the second flange members 32 being coupled to a separate portion of the clip structure 22.

Returning to FIGS. 2 and 3, the first flange member 30 is coupled to the clip structure 22 via a coupling mechanism 50. Coupling mechanisms are well known in the art and need not be discussed in significant detail herein. In the example provided, the coupling mechanism 50 is illustrated to include a plurality of weld protrusions 52 that are configured to be inserted into associated protrusion apertures 54 formed into the clip structure 22. The weld protrusions 52 are thereafter permanently deformed, by heating, for example, to fixedly couple the spacing structure 20 to the clip structure 22.

Returning to FIG. 2, clip structure 22 is illustrated to include a body portion 60 and a flange portion 62. Clip structure 22 is preferably unitarily formed from a spring steel material, such as SAE 1050 steel that has been austempered to a hardness of about 30 to 50 on the Rockwell “C” scale and finished with an appropriate rust resistant finish, such as zinc plating.

Flange portion 62 is shown to be generally rectangular and sized to fit in the recess 38 in the first flange member 30. In addition to the protrusion apertures 54, the flange portion 62 includes a key-hole aperture 70 that is aligned to the central axis 42 of the fastener 10. The key-hole aperture 70 includes a helical lip 72 that is formed in a manner that is well known in the art. The key-hole aperture 70 is sized to receive a threaded fastener 74, with the helical lip 72 engaging the threads of the threaded fastener 74.

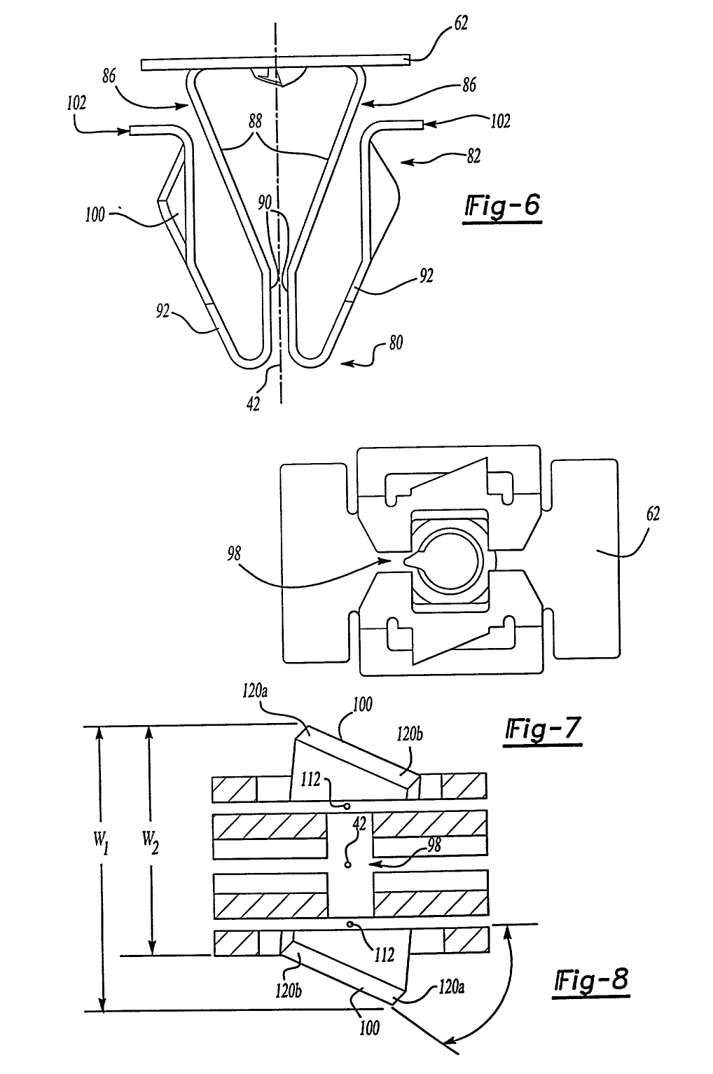

With additional reference to FIGS. 5 through 7, the body portion 60 is shown to include an insertion portion 80 and a retaining portion 82. In the particular embodiment illustrated, the insertion portion 80 is shown to include a pair of flanges 86 with each of the flanges 86 having a first portion 88, a second portion 90 and a third portion 92. The first portion 88 is coupled to the flange portion 62 at a first end and tapers inwardly toward the central axis 42 and downwardly away from the flange portion 62. The second portion 90 is coupled to an opposite end of the first portion 88 and depends downwardly therefrom in a direction generally parallel the central axis 42. The third portion 92 is coupled to the opposite end of the second portion 90, tapering outwardly from the central axis 42 and upwardly toward the flange portion 62. The first, second and third portions 88, 90 and 92 are configured in a manner so as to resiliently position the retaining portion 82 relative to the flange portion. The resilient positioning of the retaining portion 82 facilitates the installation of the fastener 10 as will be discussed in further detail, below.

In the particular embodiment illustrated, the flanges 86 also include a pair of tapered sides 96 and a fastener aperture 98 that is formed into the first, second and third portions 88, 90 and 92. The tapered sides 96 taper downwardly from the flange portion 62 and inwardly toward the central axis 42, thereby narrowing the tip of the insertion portion 80 to render the clip structure 22 easier to install. The fastener aperture 98 is primarily configured to provide clearance for the threaded fastener 74 but those skilled in the art will understand that the fastener aperture 98 may additionally or alternatively be employed to increase the flexibility of the insertion portion 80.

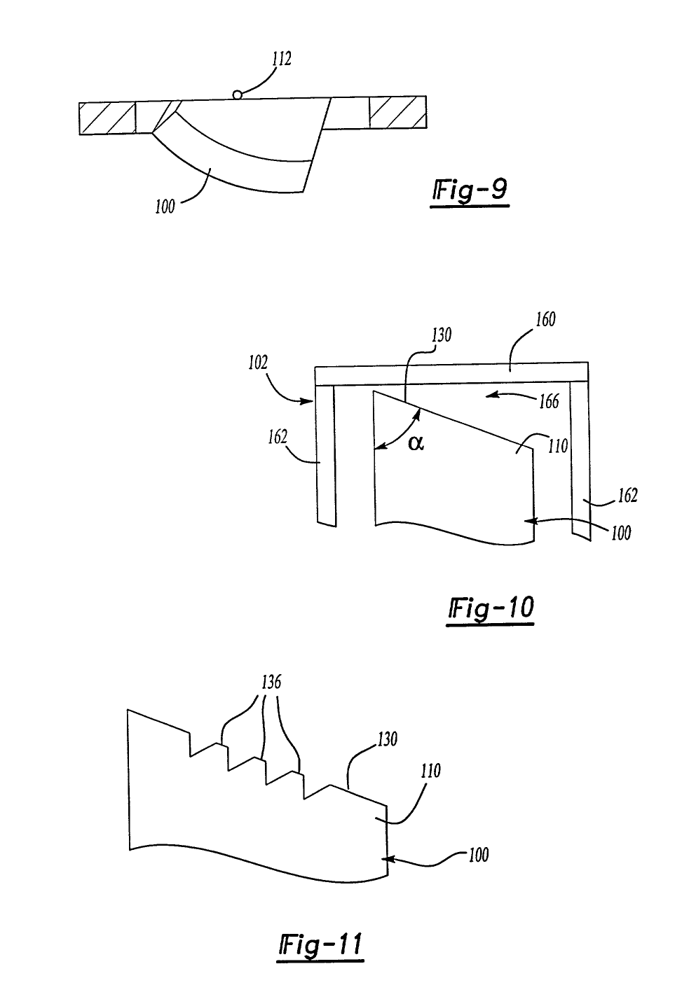

The retaining portion 82 is shown to include a pair of wing members 100 and a pair of abutting flanges 102. Each of the wing members 100 includes a base portion 108 that is fixedly coupled to the insertion portion 80. Each of the wing members 100 extends upwardly from its base portion 108 and terminates at a tip portion 110. With reference to FIGS. 5 and 8, each of the wing members 100 is illustrated to be twisted about an axis 112 in a first rotational direction such that the angle between the base portion 108 and the tip portion 110 is about 5° to about 45° and more preferably about 30°. As shown, the wing members 100 may be twisted in a manner such that each tip portion 110 lies substantially in a single plane and is parallel to the other tip portion 110. Those skilled in the art will understand, however, that each tip portion 110 may alternatively be twisted in a helical manner about their associated axis 112 as illustrated in FIG. 9.

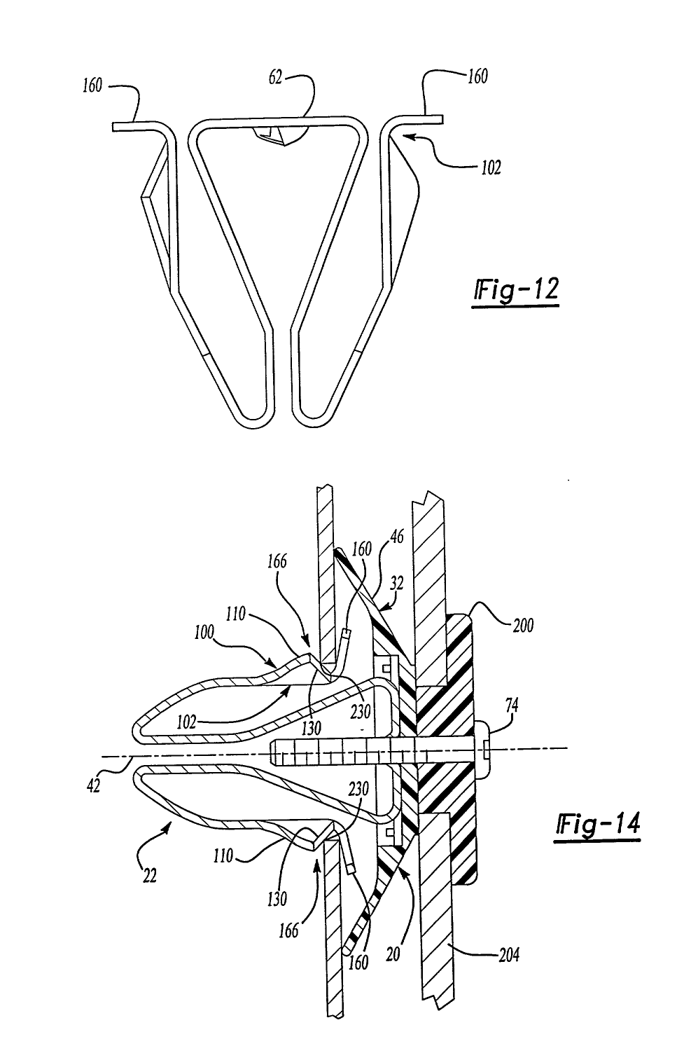

Returning back to FIGS. 5 and 8, the tip portions 110 are shown to be angled such that the lateral end 120a of the tip portion 110 nearest the central axis 42 extends above the opposite lateral end 120b (i.e., the lateral end closest the central axis 42 is also closest to the flange portion 62). With additional reference to FIG. 10, the included angle, α, of the tip portion 110 ranges from about 30° to about 80° and is more preferably about 60°. In the particular embodiment illustrated, the tip portion 110 includes a flat edge 130. As shown in FIG. 11, however, a plurality of teeth 136 may also be formed into the edge 130 of the tip portion 110. Returning back to FIG. 8, those skilled in the art will understand the construction of the wing members 100 in this manner provides the fastener 10 with an effective width of “W1” for purposes of retaining the clip structure 22 to another structure, but a narrower insertion width of “W2” for purposes of installing the clip structure 22 due to the point-loading of the tip portions 110 during the installation process.

Returning to FIG. 5, each of the abutting flanges 102 is generally U-shaped, having a base 160 that is disposed between a pair of legs 162. In the example provided, the legs 162 are coupled to the third portion 92 of an associated one of the flanges 86, extending upwards generally parallel the central axis 42 such that the base 160 is positioned above the tip portion 110 by a predetermined distance. The configuration of the abutting flange 102 is such that the abutting flange 102 is disposed at least partially over an associated one of the wing members 100, creating a gap 166 having a vertical thickness that varies due to the angle α of the tip portion 110. Those skilled in the art will understand that the retaining portion 82 may be configured to position the gap 166 relative to the flange portion 62 in a desired manner. In the particular embodiment illustrated, the bases 160 of the abutting flanges 102 are spaced apart from the flange portion 62 to thereby position the gap 166 below the flange portion 62. Another example is illustrated in FIG. 12 where the bases 160 of the abutting flanges 102 and the flange portion 62 are disposed within a common plane so as to reduce the installed height of the clip structure 22.

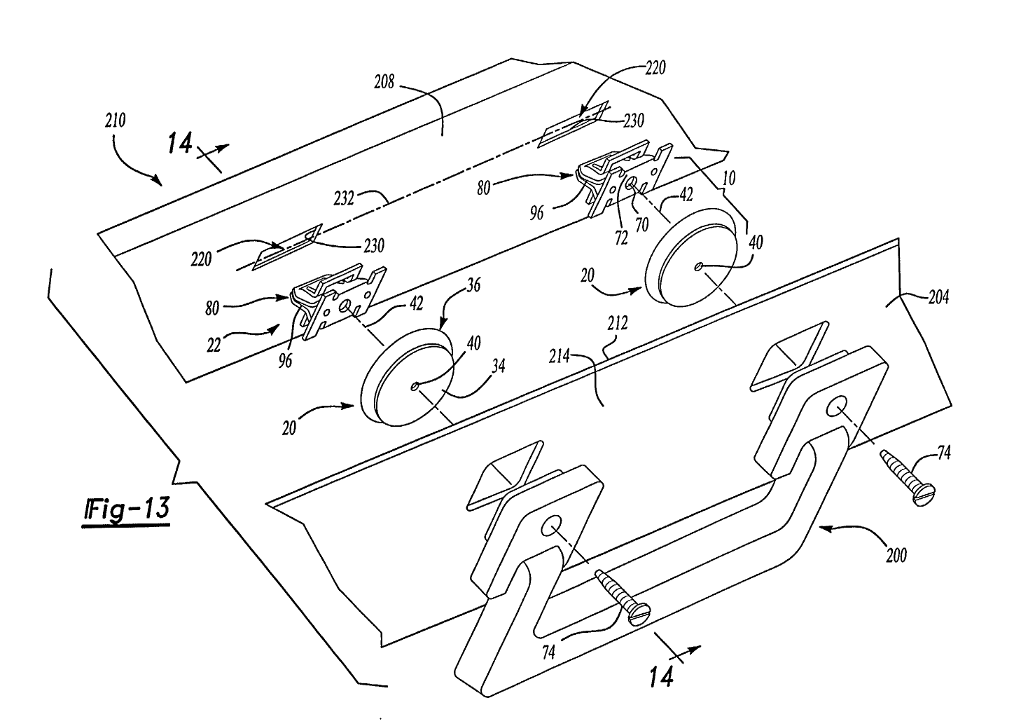

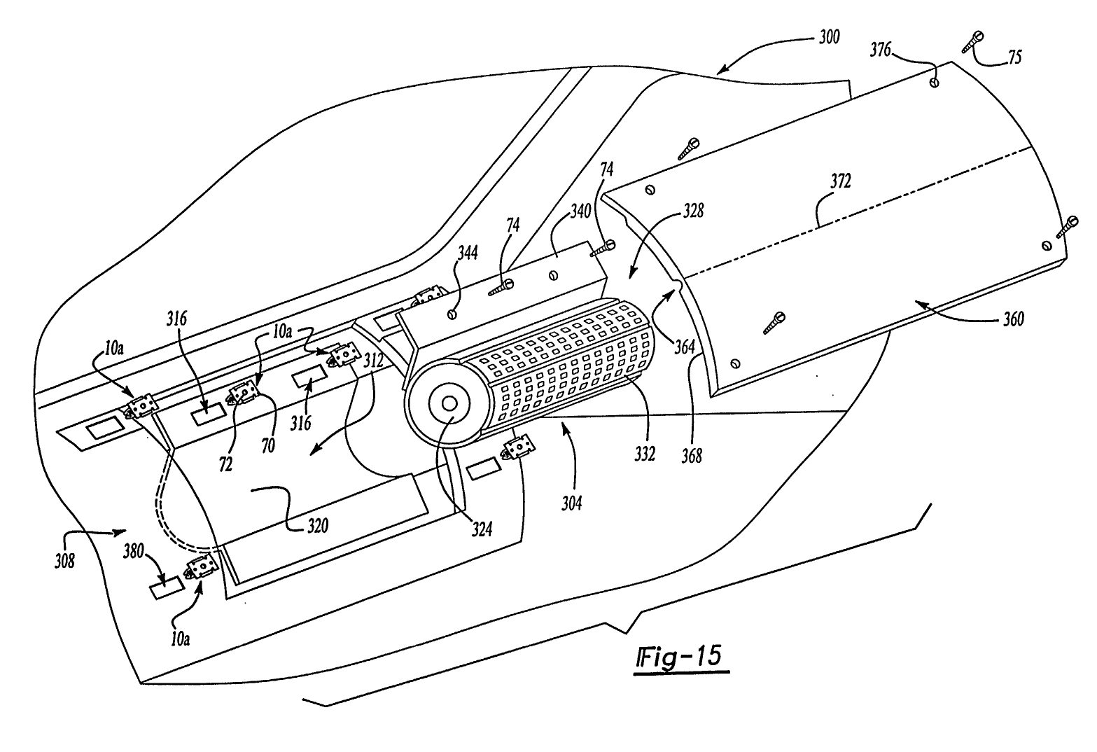

One use for the fastener 10 is illustrated in FIGS. 13 and 14. In this example, the fastener 10 is employed to retain an assist handle 200 and a headliner 204 to the roof 208 of a vehicle 210. The fastener 10 is initially positioned such that the outer surface 34 of the spacing structure 20 abuts the rear surface 212 of the headliner 204. The assist handle 200 is positioned against the front surface 214 of the headliner 204 and a threaded fastener 74 is placed through the assist handle 200, the headliner 204, the mounting hole 40 in the spacing structure 20 and threadably engaged to the helical lip 72 of the key-hole aperture 70. Threaded engagement of the threaded fastener 74 and the helical lip 72 produces a clamping force that fixedly but removably retains the assist handle 200 and headliner 204 to the fastener 10. The resultant headliner subassembly (i.e., the assist handle 200, the headliner 204, the fastener 10 and the threaded fastener 74) is next inserted through the windshield aperture or backlite aperture (not shown) in the vehicle 210 and is positioned such that the fastener 10 is proximate a slotted aperture 220.

The tapered sides 96 of the insertion portion 80 facilitate the alignment of the clip structure 22 to the slotted aperture 220, thereby reducing the need for the technician to push the fastener 10 against the roof 208 and “feel” for the slotted aperture 220. Once the clip structure 22 and the slotted aperture 220 are aligned, the technician applies an upwardly directed insertion force to the assist handle 200, pushing the clip structure 22 into the slotted aperture 220. The combination of the insertion force and contact between the edge—of the slotted aperture 220 and the wing members 100 causes the wing members 100 to deflect inwardly toward the central axis 42 until the roof 208 is disposed within the gap 166 between the tip portion 110 and the abutting flange 102. The configuration of the abutting flange 102 prevents the technician from seating the fastener 10 too deeply. Preferably, the wing members 100 are sized such that the edges 130 of the tip portions 110 engage the edges 230 of the slotted aperture 220, causing the wing members 100 to exert a force which tends to align the central axis 42 to an axis 232 of the slotted aperture 220. Construction of the fastener 10 in this manner is highly advantageous in that it enables the clip structure 22 to be engaged to the roof 208 with a relatively low insertion force yet resist withdrawal from the roof 208 even when relatively large forces are applied to the assist handle 200. In this regard, the wing members 100 can be configured to provide the fastener 10 with a ratio of insertion force to pull-out force of about 0.04 to about 0.12, and more preferably of about 0.04 to about 0.10. In the particular embodiment illustrated, the fastener may be seated with an insertion force of 20 pounds force and pulled out with a pull-out force of about 350 pounds force, thereby providing a ratio of insertion force to pull-out force of about 0.057.

Furthermore, as the angled tip portions 110 positively engage the edges 230 of the slotted aperture 220, the alignment of the fastener 10 relative to the roof 208 does not change, even when the threaded fastener 74 is removed. Construction of the fastener 10 in this manner is highly advantageous in that it eliminates the need to re-align the fastener 10 to the roof 208, headliner 204 and assist handle 200 after the headliner 204 has been removed, as when, for example, servicing of a vehicle sunroof or an overhead wire harness is necessary. This aspect of the present invention is also advantageous in that it permits the fastener 10 to tolerate a higher degree of variation in the size and location of the slotted aperture 220. Accordingly, the length of the slotted aperture 220 may sized larger than the width of the clip structure 22 without concern that the fastener 10 will move relative to the roof 208 and generate squeaks, buzzes or rattles.

Similarly, variances in the distance between the roof 208 and the headliner 204 are accommodated by the second flange member 32 of the spacing structure 20. In such instances, the wall member 46 is deflected to a greater or lesser extent after the tip portions 110 of the wing members 100 have engaged the roof 208. The spacing structure 20, by virtue of its spring-like construction, also exerts a force onto the roof 208 with further inhibits the clip structure 22 from moving relative to the roof 208.

Another example is illustrated in FIG. 15 wherein the fastener 10a is illustrated in operative association with a vehicle 300 and a passenger side airbag module 304. Those skilled in the art will understand that reference to a passenger side airbag module is merely exemplary and as such, it will be understood that the teachings of the present invention have applicability to other types of airbag modules, including side-deploying airbag modules and side-curtain airbag modules. In this example, the fastener 10a is substantially similar to the fastener 10, except that the fastener 10a does not include a spacing structure 20. As illustrated, the vehicle 300 includes a dash panel or body structure 308 that defines an airbag aperture 312. The airbag aperture 312 includes a plurality of slotted apertures 316 and a recessed cavity 320 that is sized to receive the airbag module 304. The airbag module 304 is conventional in its construction and operation and need not be discussed in detail herein. Briefly, the airbag module 304 includes an inflator 324 and a reaction canister assembly 328 having a reaction canister 332 and an inflatable airbag 336. The reaction canister 332 includes a mounting flange 340 having a plurality of holes 344, each of which is sized to receive a threaded fastener 74.

The threaded fasteners 74 are inserted through the holes 344 in the mounting flange 340 and threadably engaged to the helical lip 72 in the flange portion 62 of the fastener 10a. The assembly (i.e., airbag module 304, threaded fasteners 74 and fasteners 10a) is then placed into the recessed cavity 320, the insertion portion 80 of the fasteners 10a are aligned to the slotted holes 344 in the airbag aperture 312 and a force is exerted onto the airbag module 304 to insert the fasteners 10a into the slotted apertures 316 and engage the wing members 100 to the body structure 308. Construction in this manner is advantageous in that because the fastener 10a can be assembled to the airbag module 304 in an off-line operation, the installation of the airbag module 304 to the vehicle 300 is extremely simple and fast. Furthermore, the high pull-out force that is associated with the fastener 10a ensures that the airbag module 304 will remain coupled to the body structure 308 while the airbag 336 is being deployed.

Additional quantities of the fastener 10a are employed to secure a trim cover 360 over the recessed cavity 320 in the body structure 308. The trim cover 360 conventionally includes a notch 364 that extends along its inside surface 368 and defines a parting line 372. The trim cover 360 also includes a plurality of through-holes 344, each of which is sized to receive a threaded fastener 74 that is adapted to secure the trim cover 360 to the body structure 308. In an off-line operation similar to that employed for the airbag module 304, the threaded fasteners 74 are employed to secure the fasteners 10a to the trim cover 360. The trim cover 360 is thereafter positioned against the body structure 308, a force is exerted through the trim cover 360 and the fasteners 10a are engaged to slotted apertures 380 that are disposed around the perimeter of the recessed cavity 320.

During the deployment of the airbag module 304, gases generated by the inflator 324 fill the airbag 336, causing the inflating airbag 336 to exert a force onto the trim cover 360. Ideally, the force exerted onto the trim cover 360 causes the trim cover 360 to rip along the parting line 372 defined by the notch 364. With the known prior art fasteners, it may be possible for the airbag 336 to dislodge all or part of the trim cover from the body structure 308, rather than cause the trim cover 360 to rip. The relatively high pull-out force of the fastener 10a ensures that the trim cover 360 will remain securely fastened to the body structure 308 so that the force exerted by the inflating airbag 336 will cause the trim cover 360 to rip along the parting line 372.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A resilient clip for engaging a structure, the resilient clip comprising:
a clip structure for insertion into a hole formed into the structure, the clip structure including a body portion for engaging the structure to inhibit undesired removal of the clip structure from the hole, the clip structure also including a flange portion; and
a spacing structure having first and second flange members, the first flange member being coupled to the flange portion, the second flange member being coupled to an outer edge of the first flange member and tapering downwardly toward the body portion and outwardly from the flange portion.

2. The resilient clip of claim 1, wherein the spacing structure is formed from a resilient material.

3. The resilient clip of claim 2, wherein the resilient material is plastic.

4. The resilient clip of claim 1, wherein the spacing structure further includes a coupling member that engages and fixedly couples the flange portion to the spacing structure.

5. The resilient clip of claim 4, wherein the coupling member includes at least one weld protrusion, the weld protrusion extending through a protrusion aperture formed in the flange portion and thereafter being deformed to inhibit the withdrawal of the weld protrusion from the protrusion aperture.

6. The resilient clip of claim 1, wherein the first flange member is circular in shape.

7. The resilient clip of claim 1, wherein the second flange member extends entirely around a perimeter of the first flange member.

8. The resilient clip of claim 1, wherein the first flange member includes a recessed cavity sized to receive and locate the flange portion.

9. The resilient clip of claim 1, wherein the spacing structure is unitarily formed.

10. A resilient clip for use in securing a first member to a second member, the resilient clip comprising:
a flange portion having an aperture, the aperture adapted to receive a threaded fastener to couple the second member to the flange portion;
an insertion portion configured to be inserted into a hole formed into the first member, the insertion portion being coupled to the flange portion;
a retaining portion coupled to the insertion portion and having first and second wing members, the first wing member being twisted about a first axis in a first direction, the second wing member being twisted about a second axis in the first direction, each of the first and second wing members terminating at a tip portion that is adapted to engage the first member; and
a resilient spacing structure having first and second flange members, the first flange member being coupled to the flange portion, the second flange member being coupled to an outer edge of the first flange member and tapering downwardly toward the insertion portion and outwardly from the flange portion, the resilient spacing structure adapted to space the first and second structures apart from one another.

11. The resilient clip of claim 10, wherein the first flange member is circular in shape.

12. The resilient clip of claim 10, wherein the second flange member extends entirely around a perimeter of the first flange member.

13. The resilient clip of claim 10, wherein the spacing structure is unitarily formed.

14. A resilient clip for engaging a structure, the resilient clip comprising:
a body portion having a pair of flanges, a pair of wing members and a pair of abutting flanges, each of the wing members having a base portion coupled to an associated one of the flanges, a first one of the wing members being twisted about a first axis in a first direction, a second one of the wing members being twisted about a second axis in the first direction, each of the wing members terminating at a tip portion that is angled downwardly toward the base portion such that a portion of an associated one of the wing members nearest a central axis of the body portion extends above an associated portion of the wing member furthest from the central axis of the body portion, the tip portions being configured to engage a first side of the structure and position a second side of the structure against the abutting flanges; and
a resilient spacing structure having first and second flange members, the first flange member being coupled to the body portion, the second flange member being coupled to an outer edge of the first flange member and tapering downwardly toward and outwardly from the body portion.

15. The resilient clip of claim 14, wherein the first flange member is circular in shape.

16. The resilient clip of claim 14, wherein the second flange member extends entirely around a perimeter of the first flange member.

17. The resilient clip of claim 14, wherein the spacing structure is unitarily formed.

18. A resilient clip for engaging a structure, the resilient clip comprising:
a body portion for insertion downwardly into a hole formed in the first structure, the body portion including a plurality of wing members, each of the wing members terminating at an angled tip portion, each of the tip portions being twisted about an axis such that an inwardly twisted end of the tip portion is positioned above an outwardly twisted end of the tip portion, each of the plurality of wing members terminating at a generally flat and continuous edge for contacting an edge of the hole formed in the structure, wherein the flat edges engage the edge of the hole and inhibit relative movement between the resilient clip and the structure in a direction parallel a longitudinal axis of the hole; and
a resilient spacing structure having first and second flange members, the first flange member being coupled to the body portion, the second flange member being coupled to an outer edge of the first flange member and tapering downwardly toward and outwardly from the body portion.

19. The resilient clip of claim 18, wherein the first flange member is circular in shape.

20. The resilient clip of claim 18, wherein the second flange member extends entirely around a perimeter of the first flange member.

21. The resilient clip of claim 18, wherein the spacing structure is unitarily formed.

22. A resilient clip for engaging a structure, the resilient clip comprising:
a body portion for insertion downwardly into a hole formed in the first structure, the body portion including a plurality of wing members, each of the wing members terminating at an angled tip portion, each of the tip portions being twisted about an axis such that an inwardly twisted end of the tip portion is positioned above an outwardly twisted end of the tip portion, each of the plurality of wing members including a plurality of teeth for engaging a surface of the structure; and
a resilient spacing structure having first and second flange members, the first flange member being coupled to the body portion, the second flange member being coupled to an outer edge of the first flange member and tapering downwardly toward and outwardly from the body portion.

23. The resilient clip of claim 22, wherein the first flange member is circular in shape.

24. The resilient clip of claim 22, wherein the second flange member extends entirely around a perimeter of the first flange member.

25. The resilient clip of claim 22, wherein the spacing structure is unitarily formed.

26. In combination, a resilient clip for engaging a structure, the resilient clip comprising a body portion and a resilient spacing structure, the body portion being configured for insertion downwardly into a hole formed in the first structure, the body portion including a plurality of wing members, each of the wing members terminating at an angled tip portion, each of the tip portions being twisted about an axis such that an inwardly twisted end of the tip portion is positioned above an outwardly twisted end of the tip portion, the plurality of wing members cooperating with the structure to provide the resilient clip with a ratio of insertion force to pull-out force of about 0.04 to about 0.12, the resilient spacing structure having first and second flange members, the first flange member being coupled to the body portion, the second flange member being coupled to an outer edge of the first flange member and tapering downwardly toward and outwardly from the body portion.

27. The combination of claim 26, wherein the ratio of insertion force to pull-out force is about 0.04 to about 0.10.

28. The combination of claim 26, wherein the first flange member is circular in shape.

29. The combination of claim 26, wherein the second flange member extends entirely around a perimeter of the first flange member.

30. The combination of claim 26, wherein the spacing structure is unitarily formed.
